(19) United States
(12) Patent Application Publication
(10) Pub. No.: US 2025/0285498 A1
(43) Pub. Date: Sep. 11, 2025

(54) TRANSFER LIMIT COMPLIANCE OF GAMING ESTABLISHMENT DEVICE FUNDING VIA EXTERNAL ACCOUNT

(71) Applicant: IGT, Las Vegas, NV (US)

(72) Inventors: Jeffery Shepherd, Reno, NV (US); Kevin Higgins, Reno, NV (US)

(21) Appl. No.: 18/597,569

(22) Filed: Mar. 6, 2024

(51) Int. Cl. G07F 17/32; G06Q 50/34

(52) U.S. Cl. CPC G07F 17/3225; G06Q 50/34; G07F 17/3244

(57) ABSTRACT

Systems and methods that employ gaming establishment transfer limits in association with a transfer of funds from an external account to a gaming establishment device independent of any gaming establishment accounts, any wagering account transfers and any cashless ticket vouchers.

### BACKGROUND

In various embodiments, the systems and methods of the present disclosure employ gaming establishment transfer limits in association with a transfer of funds from an external account to a gaming establishment device independent of any gaming establishment accounts, any wagering account transfers and any cashless ticket vouchers.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF SUMMARY

In certain embodiments, the present disclosure relates to a system including a processor, and a memory device that stores a plurality of instructions. When executed by the processor responsive to a request to transfer an amount of funds from a financial institution account maintained by a financial institution to a gaming establishment device, and responsive to a transfer limit compliance determination being that the requested transfer complies with a transfer limit, the instructions cause the processor to communicate, to a server of the financial institution, data associated with the transfer of the amount of funds from the financial institution account. In these embodiments, the transfer limit compliance determination occurs independent of any component of any gaming establishment fund management system that maintains any gaming establishment accounts. When executed by the processor responsive to the request to transfer the amount of funds from the financial institution account to the gaming establishment device, and responsive to the transfer limit compliance determination being that the requested transfer fails to comply with the transfer limit, the instructions cause the processor to communicate data that results in a display, by a display device, of a notification associated with the requested transfer failing to comply with the transfer limit.

In certain embodiments, the present disclosure relates to a system including a processor, and a memory device that stores a plurality of instructions. When executed by the processor responsive to a request by a first user to transfer an amount of funds from a first financial institution account maintained by a financial institution to an electronic gaming machine, and responsive to a first transfer limit compliance determination being that the requested transfer complies with a first transfer limit associated with the first user, the instructions cause the processor to communicate, to a server of the financial institution, data associated with the transfer of the amount of funds from the first financial institution account. In these embodiments, the first transfer limit compliance determination occurs independent of the server of the financial institution, independent of the electronic gaming machine and independent any component operable to execute any wagering account transfer. When executed by the processor responsive to a request by a second user to transfer the amount of funds from a second financial institution account maintained by the financial institution to the electronic gaming machine, and responsive to a second transfer limit compliance determination being that the requested transfer fails to comply with a second, different transfer limit associated with the second user, the instructions cause the processor to communicate data that results in a display, by a display device, of a notification associated with the requested transfer failing to comply with the second, different transfer limit. In these embodiments, the second transfer limit compliance determination occurs independent of the server of the financial institution, independent of the electronic gaming machine and independent any component operable to execute any wagering account transfer.

In certain embodiments, the present disclosure relates to a method of operating a system. Responsive to a request to transfer an amount of funds from a financial institution account maintained by a financial institution to a gaming establishment device, and responsive to a transfer limit compliance determination being that the requested transfer complies with a transfer limit, the method includes communicating, to a server of the financial institution, data associated with the transfer of the amount of funds from the financial institution account. In these embodiments, the transfer limit compliance determination occurs independent of any component of any gaming establishment fund management system that maintains any gaming establishment accounts. Responsive to the request to transfer the amount of funds from the financial institution account to the gaming establishment device, and responsive to the transfer limit compliance determination being that the requested transfer fails to comply with the transfer limit, the method includes displaying, by a display device, a notification associated with the requested transfer failing to comply with the transfer limit.

Additional features are described herein, and will be apparent from the following Detailed Description and the figures.

### BRIEF DESCRIPTION OF THE SEVERAL VIEWS OF THE DRAWINGS

FIG. 1 is an example configuration of the architecture of a plurality of different components of the system of the present disclosure.

FIG. 2 is a flow chart of an example process for operating a system including various components that operate to enroll an external funding source that maintains an external account.

FIGS. 3A and 3B are flow charts of example processes for operating a system including various components that operate to utilize transfer context data to transfer funds from an external account maintained by an external funding source to a gaming establishment device independent of any gaming establishment account associated with any gaming establishment fund management system.

### DETAILED DESCRIPTION

In various embodiments, the systems and methods of the present disclosure employ gaming establishment transfer limits in association with a transfer of funds from an external account to a gaming establishment device independent of any gaming establishment accounts, any wagering account transfers and any cashless ticket vouchers.

In certain embodiments, in association with the movement of funds from an external account to a gaming establishment device, the system of the present disclosure generates and utilizes transfer context data to ensure that the funds reach the correct gaming establishment device. In these embodiments, since the transfer of funds from an external account bypasses any gaming establishment account maintained by a gaming establishment fund management system which is configured to interface with the intended destination gaming establishment device, the system employs certain transfer context data to identify the gaming establishment device where such funds are transferred to. For example, since the transfer of funds from a financial institution account (i.e., an external account) to an electronic gaming machine (i.e., a gaming establishment device) occurs independent of any cashless wagering account accessible from the electronic gaming machine, the system creates transfer context data that identifies the electronic gaming machine and associates the created transfer context data with one or more communications between the various components that effectuate the transfer of funds. In certain of these embodiments, since the transfer of funds from an external account is initiated independent of any gaming establishment device, the system further employs certain transfer context data to identify the gaming establishment device where such funds are transferred to. For example, since the initiation of a transfer of funds from a financial institution account (i.e., an external account) to an electronic gaming machine (i.e., a gaming establishment device) occurs in association with a mobile device (and independent of a user interfacing with an input device of the electronic gaming machine), the system creates transfer context data that identifies the electronic gaming machine and associates the created transfer context data with one or more communications between the various components that effectuate the transfer of funds. As such, since the transfer of funds from an external account to a gaming establishment device occurs independent of the gaming establishment device identifying itself as a destination of such funds and/or occurs independent of any gaming establishment account accessible by the destination gaming establishment device, the system creates and uses transfer context data to facilitate the transfer of funds from the external account to the gaming establishment device.

In certain embodiments, in association with the movement of funds from an external account to a gaming establishment device (and in view of the potential subsequent movement of such funds elsewhere), the system of the present disclosure imposes certain limits, such as responsible gaming limits and/or anti-money laundering limits. In certain such embodiments, since the transfer of funds from an external account bypasses any gaming establishment account maintained by a gaming establishment fund management system that otherwise includes capabilities to screen for violations of certain limits, the system operates to track funds transferred independent of the gaming establishment fund management system. In these embodiments, the system determines if any transactions, individually or collectively, violate one or more imposed limits, and takes zero, one or more appropriate actions accordingly. For example, since the transfer of funds from a financial institution account (i.e., an external account) to an electronic gaming machine (i.e., a gaming establishment device) occurs independent of any cashless wagering account maintained by a cashless wagering system that may otherwise impose funding limits, the system of the present disclosure enforces transfer limits on a periodic basis to ensure that responsible gambling limits are met and/or the system is not being abused to potentially launder money.

Accordingly, certain embodiments of the present disclosure enable a transfer of funds from an external account (e.g., a financial institution account) to a credit balance of a gaming establishment device (e.g., an electronic gaming machine) independent of such funds being transferred to any gaming establishment accounts (and thus saves users time and effort in having to set up such a gaming establishment account as well as save processing resources by reducing the quantity of accounts such funds have to travel to before reaching the destination device). Moreover, since certain gaming establishment patrons are uncomfortable venturing into a gaming establishment with large amounts of cash, the system enables a user access to an amount of funds transferred from an external account without the need to handle cash. Such reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based transactions and cashless ticket voucher-based transactions (e.g., protecting patrons from using forms of currency and/or paper cashless ticket vouchers that act as transmission vehicles for contagions), and benefits the gaming establishment by reducing the use of certain kiosks that accept cash (e.g., reducing the wear and tear on such devices and prolonging the operational life on these devices).

Additionally, by reducing the amount of cash transactions in a gaming establishment via enabling the transfer of funds from an external account to a gaming establishment device, the system reduces or eliminates human errors which often occur when cash is distributed at gaming establishment interfaces, such as casino desks and/or cashless ticket vouchers are purchased with an amount of cash at gaming establishment interfaces, such as casino desks. Specifically, eliminating gaming establishment personnel from distributing cash and/or issuing ticket vouchers in exchange for amounts of cash not only protects the user (if the gaming establishment personnel provides the gaming establishment patron a lower amount of cash and/or a lower valued cashless ticket voucher than the patron deserves) but also protects the gaming establishment (if the gaming establishment personnel inadvertently or fraudulently provides the patron a higher amount of cash and/or or a higher valued cashless ticket voucher than the patron deserves). As such, the system of the present disclosure provides an alternative, non-cash-based and non-ticket voucher-based option for a gaming establishment patron to transfer, independent of any gaming establishment accounts, funds to a gaming establishment device while complying with various anti-money laundering regulations and/or responsible gambling limitations which require the tracking of certain financial transactions associated with a gaming establishment patron.

In various embodiments, the present disclosure is directed to a system including or otherwise in communication with various components and/or sub-systems that operate together to cause a transfer of an amount of funds from an external account, such as a financial institution account, to a gaming establishment device, such as an electronic gaming machine, independent of any gaming establishment accounts, independent of any wagering account transfers and independent of any cashless ticket vouchers (e.g., an anonymous bearer instrument associated with an amount of funds and redeemable for cash via a kiosk, a cashier and/or game play on a gaming establishment device, such as an EGM). In these embodiments, the collection of components that are part of the system (or otherwise operate with one or more components of the system) facilitate a transfer funds from an external account associated with a user to a gaming establishment device without requiring the user to first transfer such funds to a gaming establishment account followed by a wagering account transfer of the funds to the gaming establishment device.

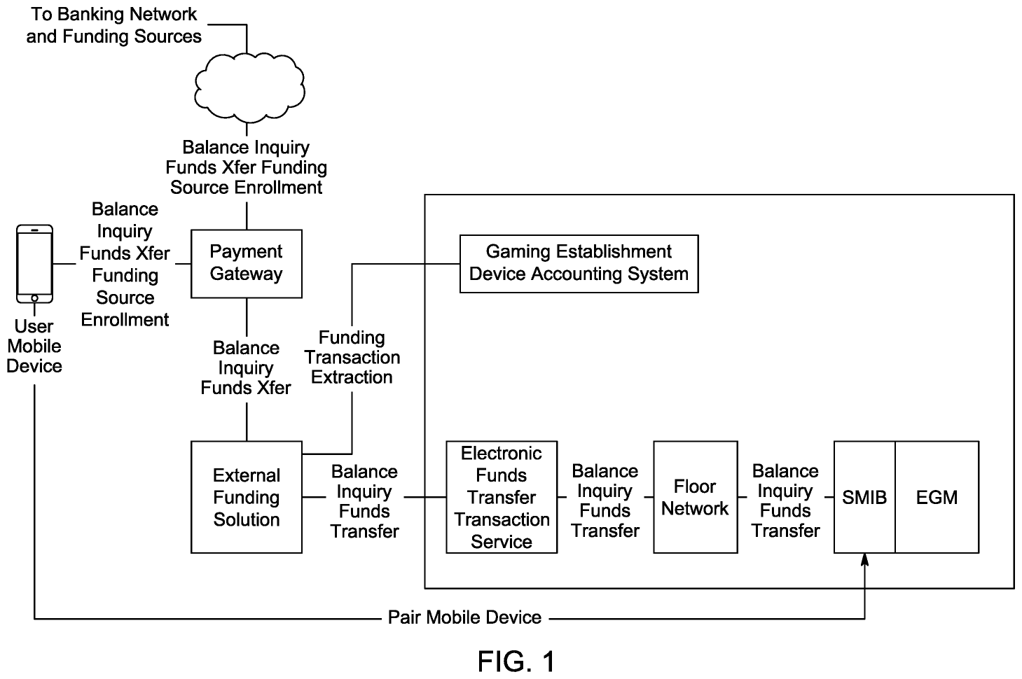

In various embodiments, the system includes or is otherwise associated with a payment gateway operable to interface with a banking network to communicate with one or more servers of one or more financial institutions that maintain one or more financial institution accounts and implement zero, one or more financial institution protocols, such as banking protocols. In such embodiments, the system includes a payment gateway operable with a banking network and one or more external funding sources (e.g., financial institutions) which maintain one or more external accounts (e.g., financial institution accounts) for a user to enable certain actions, including, but not limited to, balance inquiries, funding source enrollments and/or fund transfers. For example, as seen in FIG. 1, the system includes one or more servers operating as a payment gateway in communication with a network of one or more servers of one or more banks or other financial institutions (i.e., the banking network and funding sources) which operate to electronically transfer funds from one or more accounts maintained at such banks or financial institutions to an electronic gaming machine (“EGM”) via a series of one or more intermediaries operating directly or indirectly with the payment gateway. As also seen in FIG. 1, the payment gateway is in communication with a mobile device which enables a user to conduct balance inquiries, request funding source enrollments and/or request fund transfers from one or more external funding sources. In different embodiments, the accounts of the external funding sources include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts).

In certain embodiments, the system includes or is otherwise associated with an external funding solution operable with the payment gateway. In these embodiments, the external funding solution enables for a single entry point for all external funding transactions and if necessary, operates to disambiguate between destination sites of funds transferred from one or more external funding sources. For example, as seen in FIG. 1, the system includes one or more servers operating as an external funding solution in communication with one or more servers of the payment gateway to enable certain actions, including, but not limited to, balance inquiries, and/or fund transfers. As also seen in FIG. 1, the external funding solution is also in communication with one or more components of a gaming establishment device accounting system operable with extracting funding transaction information for accounting and auditing purposes.

In certain embodiments, the system includes or is otherwise associated with an electronic funds transfer transaction service operable with the external funding solution. In these embodiments, the electronic funds transfer transaction service operates with a gaming establishment device management system to direct funds transferred from the external funding source to the appropriate gaming establishment device. For example, as seen in FIG. 1, the system includes one or more servers operating as an electronic funds transfer transaction service in communication with the external funding solution to enable certain actions, including, but not limited to, balance inquiries, and/or fund transfers. As also seen in FIG. 1, the electronic funds transfer transaction service is also in communication with one or more components of a gaming establishment floor management system (i.e., the floor network) to enable certain actions, including, but not limited to, balance inquiries, and/or fund transfers.

In certain embodiments, the system includes or is otherwise in communication with one or more gaming establishment patron management systems that, amongst other tasks, monitor activities at various points of contact associated with a gaming establishment and provides rewards, such as redeemable player tracking points, in association with such activities. In these embodiments, one or more components of the gaming establishment patron management system that are associated with an individual gaming establishment device operate with the gaming establishment device management system to facilitate the transfer of funds from an external funding source to that individual gaming establishment device. For example, as seen in FIG. 1, the system employs a slot machine interface board (“SMIB”) (i.e., a component of a gaming establishment patron management system) associated with an EGM and in communication with one or more components of a gaming establishment floor management system (i.e., the floor network) to enable certain actions, including, but not limited to, balance inquiries, and/or fund transfers. In these embodiments, one or more components of the gaming establishment patron management system that are associated with an individual gaming establishment device also operate with a mobile device of a user to enable the component of the gaming establishment patron management system to identify, to the payment gateway, the gaming establishment device that will receive the funds from the external funding source. For example, as seen in FIG. 1, the system employs the SMIB associated with the EGM to pair with a mobile device that is in communication with the payment gateway to enable the payment gateway (and one or more intermediate components) to identify the appropriate EGM to transfer funds to.

In certain embodiments, the system utilizes one mobile device application to interact with the different components of the system to, amongst other actions, access funds maintained in the different external accounts associated with the user. In certain embodiments, the system utilizes multiple mobile device applications to interact with the different components of the system to, amongst other actions, access funds maintained in the different external accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code). Additionally, while illustrated in FIG. 1 as using a mobile device running a mobile device application to access funds associated with an external account, in different embodiments, a physical instrument, such as a smart card or a user issued magnetic stripe card (that may or may not be associated with the external account) may additionally or alternatively be utilized to enable a user access to such an external account.

While illustrated as certain systems, sub-systems or components being in communication with other systems, sub-systems or components, any system, sub-system or component of the present disclosure can be in communication with one or more other systems, sub-systems or components to facilitate, as appropriate, the transfer of funds from an external account to a gaming establishment device independent of any wagering account transfers. For example, while the payment gateway is illustrated in FIG. 1 as being in communication with a banking network and one or more external funding sources, in different embodiments, any system, sub-system or component of the present disclosure can be in communication with a banking network and one or more external funding sources.

Moreover, in certain embodiments, two or more of the systems, sub-systems and components of the present disclosure may be combined into a single system, sub-system or component. For example, while the external funding solution and the electronic funds transfer transaction service are illustrated as separate components, the external funding solution and the electronic funds transfer transaction service may be combined into a single component operable to interface with the payment gateway and the gaming establishment device management system to facilitate the transfer of funds from an external account to a gaming establishment device independent of any wagering account transfers. In another example, while the payment gateway and the external funding solution are illustrated as separate components, the payment gateway and the external funding solution may be combined into a single component operable to interface with the banking network and the electronic funds transfer transaction service (or the gaming establishment device management system) to facilitate the transfer of funds from an external account to a gaming establishment device independent of any wagering account transfers. In another example, while certain accounting and audit functions are performed by the gaming establishment device accounting system of FIG. 1, part or all of such accounting and/or audit functions may be performed by the external funding solution and/or the electronic funds transfer transaction service.

It should be appreciated that while illustrated in FIG. 1 as a mobile device running a mobile device application being in communication with certain components of the present disclosure, any suitable device, such as, but not limited to, a kiosk, a gaming establishment device (e.g., an interface of a gaming device, such as an EGM, or an interface of a non-gaming device, such as a retail point-of-sale terminal associated with a gaming establishment), an externally controlled interface displayed by a gaming establishment device (e.g., a remote host controlled service window displayed by an EGM), a component of a gaming establishment patron management system, such as a player tracking unit, and/or a gaming establishment interface, may be in communication with certain components of the present disclosure to facilitate the transfer of funds from an external account to a gaming establishment device independent of any wagering account transfers.

It should be further appreciated that while illustrated in FIG. 1 as funds accessed from an external funding source being transferred to an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)), in different embodiments, funds accessed from an external funding source may be transferred to any suitable non-EGM gaming establishment device operable to receive funds, such as, but not limited to, a kiosk or a retail point-of-sale terminal associated with a gaming establishment.

As described in more detail below, in certain embodiments, the system enables a transfer of funds between different external accounts and different gaming establishment components to enable different gaming activities and/or non-gaming activities. In these embodiments, the system employs a service for interfacing with the various components to facilitate balance inquiries and the transfer of funds independent of any wagering account transfers. In certain embodiments, such a service collects data from various components and utilizes such collected data to provide a singular view of the balances (or a plurality of singular views of different groupings of balances) available. As also described in more detail below, in certain embodiments, such a service additionally or alternatively provides facilities to enforce rules and/or limitations including, but are not limited to, jurisdictional controls, self-imposed limits, state governmental controls and federal governmental controls, wherein the system provides the logic to determine how, and how much, to transfer to satisfy a request for funds while staying within the confines of such rules. In certain embodiments, such a service additionally or alternatively tracks and coalesces transaction history of the interconnected components of the system. In these embodiments, all transactions within the system have a “master” transaction record that ties all of the various fund transfers to a single initiating funds transfer regardless of how many accounts were withdrawn to the satisfy the original request.

In various embodiments, prior to transferring funds associated with an external account maintained by an external funding source to a gaming establishment device, such as an EGM, the user enrolls or otherwise associates an external account maintained by an external funding source. In certain embodiments, if the user has not previously enrolled the external account and/or the external funding source with the payment gateway, the system enables the user to enroll the external account and/or the external funding source with the payment gateway. For example, the system of the present disclosure enables a user to enroll a bank account with the system using a mobile device application. In certain instances, such enrollment occurs independent of requiring the user to logon to any gaming establishment mobile device application or otherwise identify themselves to a gaming establishment patron management system. In these instances, the user remains anonymous to the gaming establishment because the act of enrolling the bank account maintained by the bank is between the user, the mobile device application and the user's bank.

In various embodiments, to enroll an external account and/or an external funding source with the payment gateway, the system enables a user to utilize an interface, such as a mobile device application being executed by a mobile device, a website accessed from a browser, a kiosk and/or a service window displayed by EGM (or other gaming establishment device), to attempt to complete the enrollment through one or more interactive forms. For example, as part of enrolling an external account and/or an external funding source, the user makes one or more inputs via an interface to provide certain user identifying information (such as, but not limited to, name, address, birthdate, state of birth, additional address details, a social security number and/or a mother's maiden name) and/or certain external account identifying information (such as, but not limited to, an identification of a funding source, an external account number, a unique username/password combination associated with the user to access the external account).

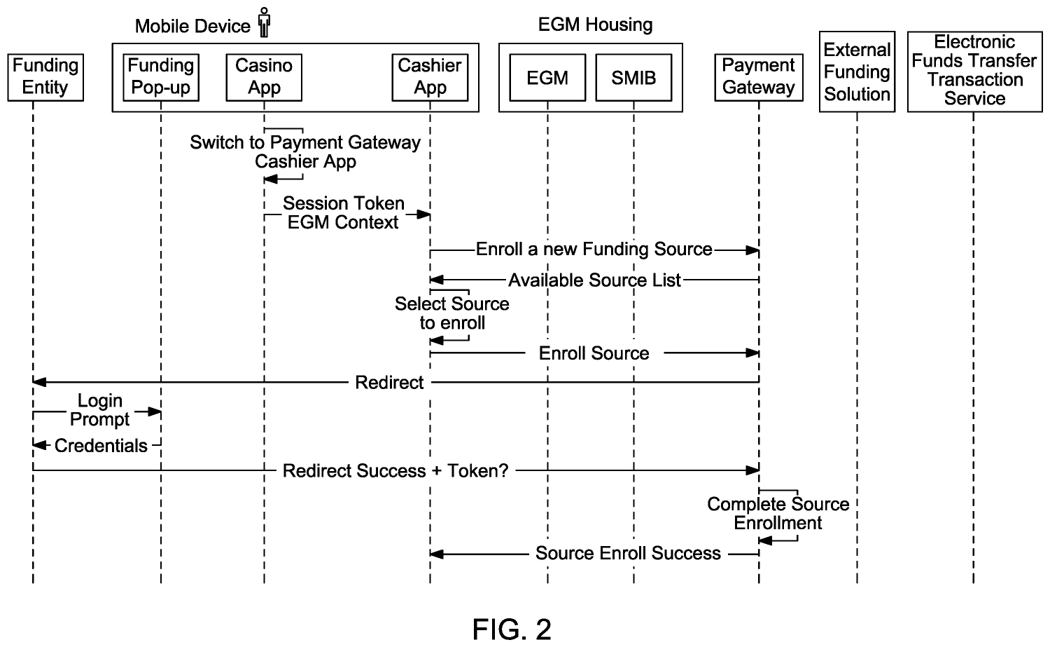

Accordingly, in various embodiments, the system of the present disclosure enables a user to enroll an external account maintained by an external funding source with the payment gateway to enable the transfer of funds from the external account to a gaming establishment device independent of any wagering account transfers. For example, as seen in FIG. 2 (which illustrates the described interactions between a mobile device executing mobile device applications, the payment gateway and the external funding source), certain embodiments of enrolling an external account maintained by an external funding source with the payment gateway include a user employing a gaming establishment mobile device application (i.e., the casino app) to access a mobile device application associated with a funding source (i.e., the cashier app) to enable the payment gateway to interface with one or more servers of the funding source (i.e., the funding entity) to enroll the external account maintained by the external funding source such that subsequent transfers to the gaming establishment device are separately available to potentially occur.

In certain embodiments, as part of enrolling an external account and/or an external funding source, the system determines zero, one or more security measures to invoke in association with one or more (or each) transaction that involves funds transferred from the external account. In these embodiments, to prevent unauthorized access to the funds associated with such an external account, the system applies such determined security measures in association with one or more (or each) transaction that attempts to transfer funds from the external account. In certain embodiments, as part of enrolling an external account and/or an external funding source, the system determines one or more controls or restrictions to associate with the external account wherein if such controls are violated, the system invokes one or more security measures. In these embodiments, to balance the need to prevent unauthorized access to the funds associated with an external account against the need to provide a frictionless experience for users, the system dynamically employs one or more security measures such that certain transactions that trigger the need to employ enhanced security measures and certain transactions that do not trigger the need to employ enhanced security measures. It should be appreciated that an enhanced security measure includes any form of security that was not otherwise associated with the transaction prior to the determination that the nature of the transaction warranted an additional degree of protection to combat any attempted fraud associated with the transaction. For example, if a user is required to enter a personal identification number (“PIN”) for each attempted transfer of funds from an external account regardless of any determination that the nature of the transaction warrants any additional degree of protection to combat any attempted fraud associated with the transaction, such a PIN would not qualify as an enhanced security measure. In another example, if a user is not required to enter a PIN for each attempted transfer of funds from an external account but following a determination that the nature of the transaction warrants requiring the user to enter a PIN as an additional degree of protection to combat any attempted fraud associated with the transaction, such a PIN would qualify as an enhanced security measure. In certain embodiments, the external account is associated with a transaction completion time (i.e., an amount of time a financial institution associated with the external account needs to approve or disapprove the fund transfer and make the amount of funds available). As such, since different external accounts are associated with different transaction completion times, the user may enroll different external accounts and utilize the funds from different external accounts at different points in time based on the respective transaction completion times of these different external accounts.

In certain embodiments, following the enrollment of an external funding source and/or an external account associated with a user, to request a transfer of an amount of funds from the external account maintained by the external funding source to the gaming establishment device, the system requires the user to pair a mobile device with the gaming establishment device. Such pairing enables the system to create transfer context data utilized by one or more components of the system to ensure that the funds are delivered to the intended gaming establishment device. For example, to transfer an amount of funds from an external account associated with a financial institution to an EGM without employing any gaming establishment accounts and/or wagering account transfers, the system requires the user to pair a mobile device (which is executing a gaming establishment mobile device application operable to access or otherwise launch a mobile device application associated with the financial institution) with a SMIB (i.e., a component of the gaming establishment patron management system) associated with the EGM. The result of this pairing enables the system to generate transfer context data that includes an identification of the EGM and the gaming establishment (and/or a gaming establishment site if the gaming establishment is associated with multiple sites) that is subsequently used to ensure that the funds are transferred to the correct EGM at the correct gaming establishment.

In certain embodiments, the pairing between a mobile device and a component of a gaming establishment patron management system associated with a gaming establishment device is accomplished by one or more wireless communication protocols between the mobile device and the component of the gaming establishment patron management system associated with a gaming establishment device (or the gaming establishment device itself). In certain embodiments, the communication with the mobile device can occur through one or more wireless interfaces of the gaming establishment device (described herein as an EGM but not otherwise limited to an EGM) and/or the component of the gaming establishment patron management system (described herein as a SMIB but not otherwise limited to a SMIB) associated with the gaming establishment device. Such wireless interfaces are configured to receive information, such as transfer context data, employed to facilitate a transfer of funds from an external account to an EGM independent of any gaming establishment accounts.

In one embodiment, the wireless interface is integrated into a device mounted to and/or within the gaming machine cabinet, such as a SMIB associated with a card reader or a player tracking unit. In another embodiment, the wireless interface is integrated into the cabinet of the EGM and the EGM processor is configured to communicate directly with and send control commands to the wireless interface. In certain embodiments where the wireless interface is embedded in a secondary device, such as a SMIB, the EGM processor sends control commands to control the wireless interface via a secondary controller.

In certain embodiments, the wireless interface implements one or more wireless communication protocols including, but not limited to: Bluetooth™, Bluetooth™ Low Energy (“BLE”), one or more cellular communication standards (e.g., 3G, 4G, 5G, 6G, LTE), and/or one or more Wi-Fi compatible standards to facilitate the pairing between the mobile device and the SMIB (or the EGM) to enable a transfer of funds from an external account to the EGM.

In certain such embodiments, Bluetooth™ pairing occurs when two Bluetooth devices agree to communicate with each other and establish a connection. In order to pair two Bluetooth wireless devices, a password (passkey) is exchanged between the two devices. The Passkey is a code shared by both Bluetooth devices, which proves that both users have agreed to pair with each other. After the passkey code is exchanged, an encrypted communication can be set up between the pair devices. In Wi-Fi paring, every pairing can be set up with WPA2 encryption or another type of encryption scheme to keep the transfer private. Wi-Fi Direct is an example of a protocol that can be used to establish point-to-point communications between two Wi-Fi devices. The protocol enables for a Wi-Fi device pair directly with another without having to first join a local network. In such embodiments, utilizing a Wi-Fi/Bluetooth™ communications protocol implementation, the mobile device communicates with the SMIB (or the EGM) via a Wi-Fi/Bluetooth™ communications protocol.

In certain embodiments which implement a wireless communication protocol, such as a Wi-Fi, cellular and/or Bluetooth™ communication protocol, the system utilizes one or more QR codes to facilitate the communication of data between the mobile device and the SMIB (or the EGM). In such embodiments, the QR code is used to identify the SMIB, the EGM and/or a server to which the mobile device should connect. In certain embodiments, the QR code enables the establishment of a secure tunnel or path from the mobile device to the gaming establishment's Wi-Fi network and then to the gaming establishment's wired network and finally to the SMIB (or the EGM). In these embodiments, a communication tunnel wrapper (e.g., a Wi-Fi/Bluetooth™ tunnel wrapper) is utilized to establish a connection between the SMIB (or the EGM or a server associated with the SMIB or associated with the EGM) and the mobile device and to transport any data messages between the SMIB (or the EGM or a server associated with the SMIB or associated with the EGM) and the mobile device.

In certain embodiments, the QR code comprises a static QR code, such as a sticker or metallic plate affixed to the EGM. In certain such embodiments, the QR code uniquely identifies the particular SMIB (or the EGM) directly or indirectly, such as representing a value in a database that is associated with that particular SMIB (or particular EGM). In certain embodiments, the QR code comprises a dynamic QR code that is displayed by a display device associated with the SMIB (or the EGM), such as a QR code displayed by a service window. In these embodiments, a user requests, via an input at the SMIB, the EGM and/or the mobile device, the generation of a QR code. In response to the request, the SMIB or the EGM displays a QR code. Such an on-demand QR code remains valid for a designated amount of time such that if the user does not scan the QR code within the designated amount of time, another QR code is necessary to be scanned to connect the mobile device to the SMIB (or the EGM). For example, a QR code is displayed for thirty seconds after which the QR code is no longer displayed. In this example, if another user attempts to scan the QR code after this thirty second window, that other user would need to request, via an input at the SMIB or the EGM, the generation of another separate QR code. As such, to avoid the QR code displayed in association with a given EGM from always have the same data embedded in it because an intruder could scan the QR code and then try to login an hour later to that same EGM, the system requires the user to engage a button on the SMIB or the EGM to display the QR code. This engagement triggers a new QR code that has a unique nonce in it which prevents a third-party (e.g., another user) from sniping information utilized to facilitate the transfer of funds from the external account to the EGM.

In certain embodiments, a user scans a QR code with the mobile device application. If the system determines that the QR code is valid (i.e., not expired), the mobile device application will connect to one or more components of the system, such as the SMIB, the EGM and/or a server operable to identify the SMIB or the EGM. For example, when the mobile device connects to a scalable server, a validation occurs of the nonce scanned and presented to the scalable server. In this example, only if the nonce matches will the system enable the connection. It should be appreciated that as long as the established connection between the mobile device and the system remains active, one or more servers and mobile device may communicate data, such as status updates, as necessary. It should be further appreciated that in association with the wireless communications protocol that employ a QR code, any action requested by the user via the mobile device application does not require a new engagement between the mobile device and the SMIB or the EGM, such as a new scanning of the QR code to send such a requested action from the mobile device to the SMIB, to the EGM and/or to one or more servers and then from one or more servers to the SMIB or the EGM.

In certain embodiments, the wireless interface implements an NFC protocol to facilitate the pairing of the mobile device with the SMIB (or the EGM) to enable the transfer of funds from an external account to the EGM. NFC is typically used for communication distances of four cm or less. NFC enables for transactions, data exchange, and connections with a touch. NFC's short range helps keep encrypted identity documents private. As such, a tap of a mobile device with an NFC chip to an EGM can cause a pairing between the SMIB (or the EGM) and the mobile device.

Specifically, utilizing an NFC implementation, a mobile device communicates with the SMIB (or the EGM) via an NFC protocol. In such embodiments which utilize the NFC implementation, the mobile device application registers a mobile device application with one or more processors of the mobile device. When the mobile device is detected by an NFC reader of or otherwise associated with the SMIB located inside the EGM (or the EGM), the SMIB communicates one or more data messages to the mobile device (or to one or more servers which then communicate such data messages to the mobile device). Such data messages are commands generated by the SMIB (or the EGM) when the mobile device is detected in the NFC reader field. The processor of the mobile device communicates the data message to the registered mobile device application. The mobile device application responds, such as communicating a triggering message, and a communication channel is opened between the SMIB (or the EGM) and the mobile device application (or between the SMIB, the EGM, and/or one or more servers and the mobile device application). This open communication channel enables the SMIB (or the EGM) to send, though the NFC reader, additional data messages to the mobile device (or to the mobile device via one or more servers) which are responded to by the mobile device application of the mobile device. It should be appreciated that as long as the mobile device remains within the NFC field, the SMIB (or the EGM) is configured to communicate with the mobile device and send data, such as status updates, as necessary. However, once the mobile device is removed from the NFC field, the communication channel is closed and such status updates must be discontinued.

It should be appreciated that Wi-Fi, cellular, Bluetooth™, BLE communication protocols can be used in lieu of or in combination with NFC. For instance, an NFC communication can be used to instantiate a Wi-Fi or Bluetooth™ communication between the SMIB, the EGM, and/or zero, one or more servers and a mobile device, such as secure pairing using one of these protocols. That is, in one embodiment, an NFC interface can be used to set-up a higher speed communication with the NFC enabled mobile device. The higher speed communication rates can be used for expanded content sharing. For instance, a NFC and Bluetooth enabled EGM can be tapped by an NFC and Bluetooth enabled mobile device for instant Bluetooth pairing between the devices and zero, one or more servers. Instant Bluetooth pairing between an EGM, an NFC enabled mobile device and zero, one or more servers, can save searching, waiting, and entering codes. In another example, an EGM can be configured as an NFC enabled router, such as a router supporting a Wi-Fi communication standard. Tapping an NFC enabled mobile device to an NFC enabled and Wi-Fi enabled EGM can be used to establish a Wi-Fi connection between the devices and zero, one or more servers.

In certain embodiments which utilize one or more of the communication protocols described herein, any action requested by the user via the mobile device application requires a new engagement between the mobile device and the SMIB (or the EGM), such as a new tap of the mobile device to a designated location of the EGM. In certain other embodiments which utilize one or more of the communication protocol described herein, certain actions requested by the user via the mobile device application requires a new engagement between the mobile device and the SMIB (or the EGM), such as a new tap of the mobile device to a designated location of the EGM and other actions requested by the user via the mobile device application do not require any new engagement between the mobile device and the SMIB (or the EGM).

In certain embodiments, following the pairing between the mobile device executing a mobile device application and the SMIB (or the EGM), the system creates transfer context data that includes certain identifying information used in association with a potential transfer of funds from an external account to an EGM. In these embodiments, when the user's mobile device is paired with the SMIB (or the EGM), the system generates transfer context data (which, as described below is stored in one of the intermediary processes and only accessed when required or becomes part of the end-to-end transfer request enabling any intermediary access to the transfer context data to facilitate that intermediary process to act accordingly) to ensure that any funds are communicated to the appropriate EGM that the user paired their mobile device with. In other words, in certain instances, the pairing between the mobile device and the gaming establishment device causes an occurrence of a transfer context data creation event that results in the creation of transfer context data employed in the transfer of funds from an external account to a destination gaming establishment device independent of other ways to identify the gaming establishment device. In certain embodiments, the transfer context data includes certain information associated with a target destination of any requested funds from an external account. Such transfer context data includes one or more of siteID data (i.e., the target site ID for any funds), and/or EGMID data (i.e., any unique EGM identifier including, but not limited to, an EGM asset number, and/or a gaming establishment floor location, identifying the target EGM for any funds).

In certain embodiments, following the pairing between the mobile device executing a mobile device application and the SMIB (or the EGM) and the user making one or more inputs to request a transfer of funds from an external account to the EGM, the system creates transfer context data that includes certain identifying information used in association with the requested transfer of funds from the external account to the EGM. In such embodiments, the request to transfer funds from an external account to a gaming establishment device causes an occurrence of a transfer context data creation event that results in the creation of transfer context data employed in the transfer of funds from the external account to that gaming establishment device independent of other ways to identify the gaming establishment device. In different embodiments, the transfer context data additionally includes certain information associated with the request of funds from the external account, such as, but not limited to one or more of txnTime data (i.e., the time at which a requested transaction began), and ttlInSeconds data (i.e., the time to live for the requested transaction after which it should be denied). In such embodiments, certain transfer context data is generated following the mobile device pairing with a SMIB (or an EGM), and certain other transfer context data is generated in association with a request of an amount of funds from an external account to a specific EGM.

In addition to creating transfer context data to aid in the identification of an EGM to potentially receive funds from an external account, following the user selecting an external funding source and indicating an amount of funds to transfer from the external account, the system initiates a requested transfer of funds from the external funding source to the EGM identified by the transfer context data. In these embodiments, following any required authentication with the funding source and subject to the transfer being approved, one or more components of a financial institution system that maintains the external account operate to transfer an amount of funds from the external account to a target EGM via one or more intermediate components of the system of the present disclosure that individually or collectively utilized the context transfer data to ensure that the funds reach the target destination.

In certain embodiments, the system employs the paired mobile device executing a mobile device application that a user interfaces with to log into an enrolled external account maintained by the external funding source and interact with the payment gateway. In certain such embodiments, the mobile device application enables the user to input data for accessing the external account and/or information regarding the amount of the transfer using one or more input devices of the mobile device, such as inputting a PIN and/or scanning a payment instrument associated with the external account (e.g., a debit card or a credit card). For example, following the launching of the mobile device application, such as following the user selecting an image associated with the external account stored via a digital wallet application or following the mobile device application retrieving data associated with an external account stored via a digital wallet application, the mobile device application prompts the user to make zero, one or more inputs to select a funding source and, in certain instances, authenticate that funding source, such as authenticating an external account and/or confirming information associated with the external account (e.g., confirming a CVC or CVV code on a debit card associated with a checking account).

In certain embodiments, the mobile device communicates, to the payment gateway, certain data for identifying the external account, data for identifying the user and/or data for authenticating the external account or the user, such as, but not limited to, an identification of a funding source, an external account number, a unique username/password combination associated with the user to access the external account, a PIN to access the external account, biometric data received by a biometric sensor (e.g., a fingerprint sensor, a retinal sensor, a voice sensor, or a facial-recognition sensor) of the mobile device to access the external account and/or any other suitable information. In these embodiments, the payment gateway employs the data communicated from the mobile device to interact with the banking network and the external funding source to at least partially facilitate the transfer of funds from the external account. In certain other embodiments, a user is associated with default funding data, such as a default funding source, a default external account, a default transfer amount and/or a default payment instrument, such that following the identification of the target EGM, the payment gateway employs the associated default funding data to interact with the banking network and the external funding source to at least partially facilitate the transfer of funds from the external account.

Following the payment gateway receiving the data for accessing the external account (either from the mobile device, a server in communication with the mobile device, or from the user independent of the mobile device, such as via a kiosk reading information from a debit card associated with the external account), the payment gateway proceeds with operating with one or more components that operate to log the user into the external account to initiate any transfers of funds from such an external account. That is, to transfer funds from an external account, the payment gateway communicates data regarding the requested transfer of funds to one or more servers of a financial institution that maintains the external account. The one or more servers of the financial institution that maintain the external account then determines whether or not to authorize the requested transfer of funds from the external account.

If the determination is to not authorize the requested transfer of funds (i.e., the external account lacks adequate funds to cover the requested transfer and/or the requested transfer is otherwise in violation of one or more rules and regulations), the one or more servers of the financial institution denies the requested transfer of funds and communicates data of the denied transfer to the payment gateway and/or the mobile device. In certain embodiments, such a denial of the transfer is associated with the display of one or more denied transfer messages to the user.

On the other hand, if the determination is to authorize the requested transfer of funds (i.e., the external account has adequate funds to cover the transfer and the requested transfer is otherwise in compliance with zero, one or more rules and regulations), the one or more servers of the financial institution communicates data associated with the authorization of the transfer to the payment gateway. The payment gateway of these embodiments then operates with zero, one or more components of the system of the present disclosure to cause a transfer of the amount of funds from the external account to the EGM identified in association with the transfer context data. Put differently, following the external funding source authorizing the transfer of funds from an external account maintained by the external funding source, the external funding source transfers fund data to the payment gateway which then transfers part or all of such fund data to zero, one or more other components of the system (e.g., the external funding solution and the electronic funds transfer transaction service) which operate, individually or collectively, to transfer such funds to the EGM identified in association with the transfer context data. Following the successful transfer of funds to the EGM, the EGM increases one or more Electronic Funds Transfer In meters of the EGM to account for the transfer of funds from the external account and the EGM increases a displayed credit balance of the EGM to account for the transfer of funds from the external account. In addition to increasing one or more meters, the system logs such a financial transaction in a durable store, such as a relational database, to enable accounting and/or auditing of such a financial transaction if needed. In certain embodiments, such an approval and/or completion of the transfer is associated with the display of one or more approved and/or completed transfer messages to the user.

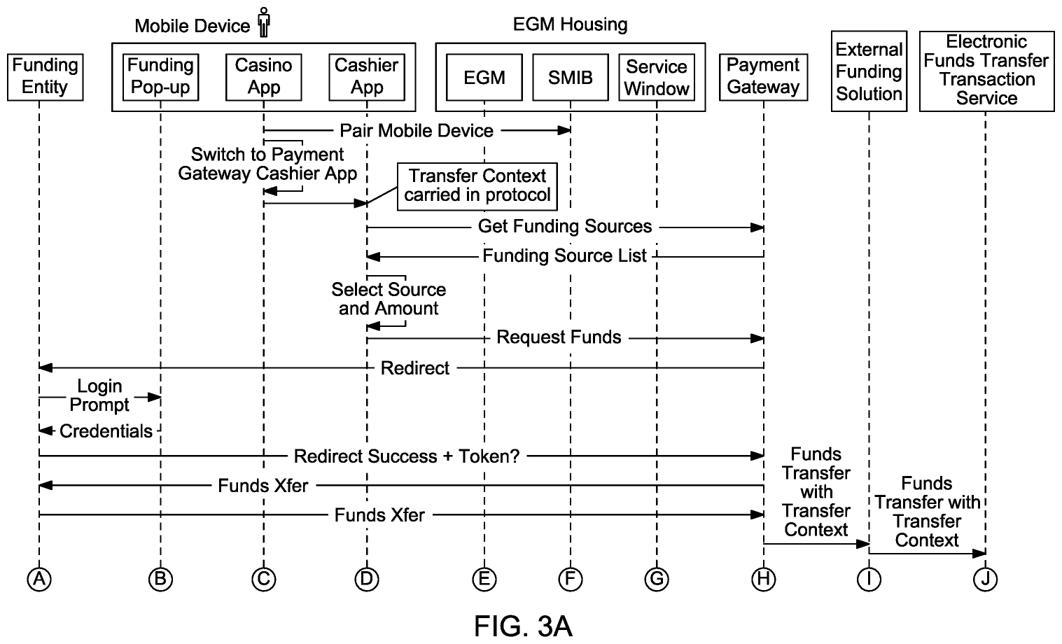

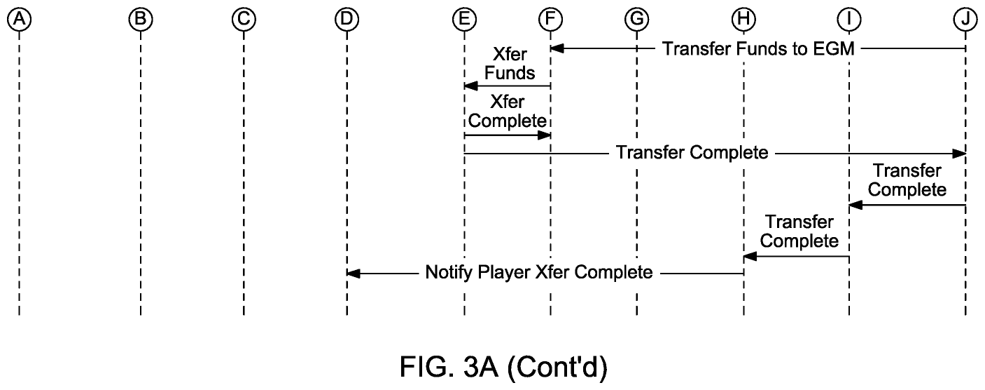

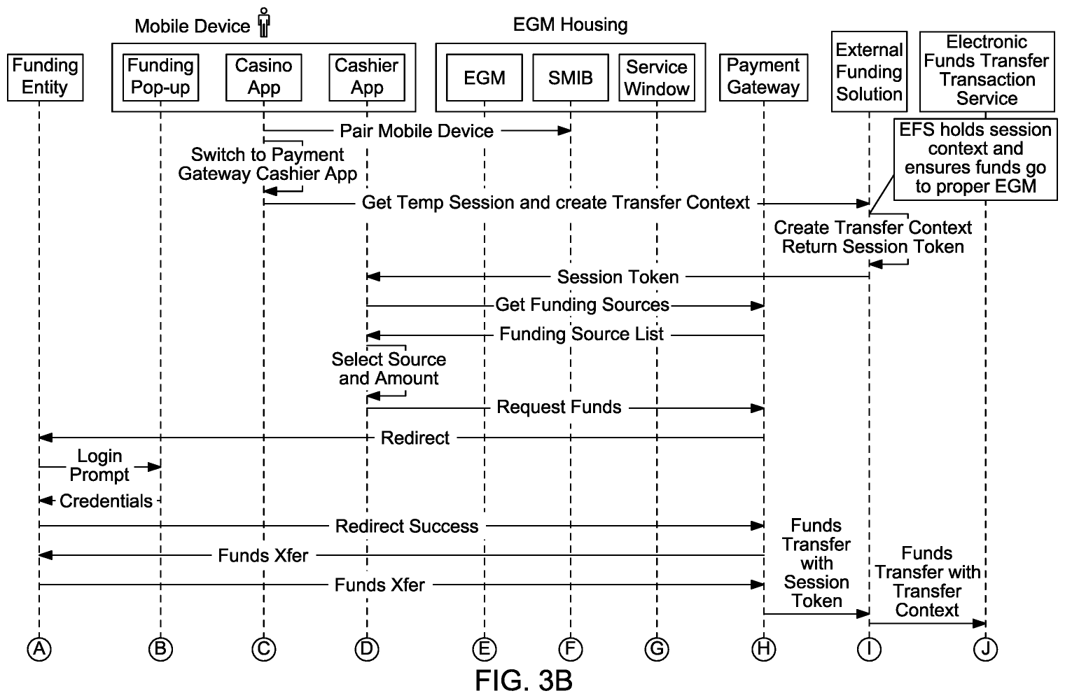

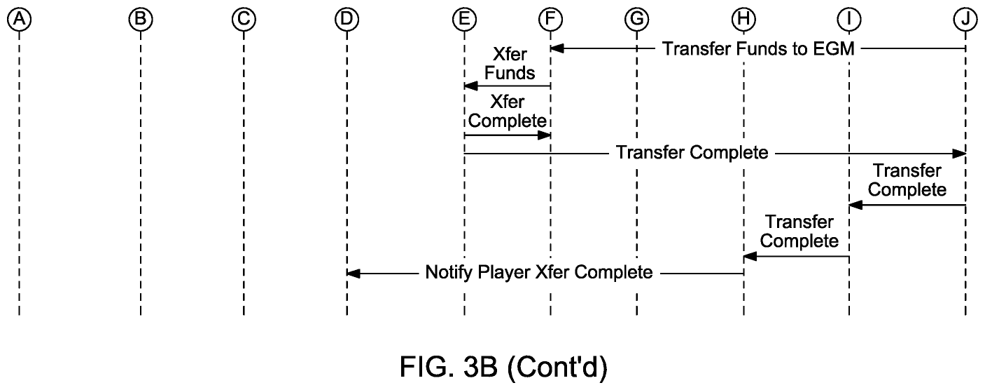

In certain embodiments, since the system employs the transfer context data to ensure that the correct EGM is the destination of the funds from the external account, the transfer context data is carried end-to-end in the protocol such that the created transfer context data is communicated to each component of the system that operates to cause a transfer of an amount of funds from an external account to an identified EGM. For example, as seen in FIG. 3A (which illustrates the described interactions between an external funding source, a mobile device executing mobile device applications, an EGM, a SMIB associated with the EGM, the payment gateway, the external funding solution and the electronic funds transfer transaction service), certain embodiments of transferring funds from an external account maintained by an external funding source to an EGM associated with a SMIB paired to a mobile device include a user employing a gaming establishment mobile device application (i.e., the casino app) to access a mobile device application associated with a funding source (i.e., the cashier app) and the payment gateway interfacing with one or more servers of the funding source (i.e., the funding entity) and various intermediate components, such as the external funding solution and the electronic funds transfer transaction service to cause the funds to flow to the correct EGM independent of any gaming establishment accounts or any wagering account transfers. As seen in FIG. 3A, to ensure that the funds from the external account reach the target destination EGM, the system communicates the transfer content data to each applicable component such that each applicable component is aware of the destination of such funds.

In certain other embodiments, since the system employs the transfer context data to ensure that the correct EGM is the destination of the funds from the external account, the transfer context data is created and maintained in association with the intermediary component responsible for ensuring that the amount of funds from the external account are transferred to the correct EGM. For example, as seen in FIG. 3B, to ensure that the funds from the external account reach the target destination EGM, the system employs the external funding solution to create the transfer context data and communicate such transfer context data as needed for the funds from the external account to reach the correct destination.

In certain embodiments, as illustrated with these examples, certain intermediary components pass the transfer context data onto another component and certain other intermediary components utilize the transfer context data to ensure that the funds reach the identified EGM. For example, if a gaming establishment is associated with multiple sites, an intermediary component that is aware of these multiple gaming establishment sites provides the disambiguation between such sites to enable for the successful transfer from the funding source to the correct gaming establishment site and the correct EGM within that site. In other words, the system provides that a transfer from a funding source is first routed to a multi-site aware intermediary component and that multi-site aware intermediary component determines which site specific intermediary component to forward the transaction to. In another example, certain intermediary components operate to provide protocol translations between intermediaries components and/or transaction logging for accounting and/or auditing purposes (e.g., to be reported to one or more accounting systems).

It should thus be appreciated that in certain embodiments, in association with the movement of funds from an external account to a gaming establishment device, the system of the present disclosure generates and utilizes transfer context data to ensure that the funds reach the correct gaming establishment device. In these embodiments, since the transfer of funds from an external account bypasses any gaming establishment account maintained by a gaming establishment fund management system configured to interface with the intended destination gaming establishment device, the system employs certain transfer context data to identify the gaming establishment device where such funds are transferred to. For example, since the transfer of funds from a bank account to an EGM occurs independent of any cashless wagering account accessible from the EGM, the system creates transfer context data that identifies the EGM and associates the created transfer context data with one or more communications between the various components that effectuate the transfer of funds. As such, since the transfer of funds from an external account to a gaming establishment device occurs independent of the gaming establishment device identifying itself as a destination of such funds and/or occurs independent of any gaming establishment account accessible by the destination gaming establishment device, the system creates and uses transfer context data to facilitate the transfer of funds from the external account to the gaming establishment device.

Accordingly, certain embodiments of the present disclosure enable a transfer of funds from an external account to a balance of a gaming establishment device independent of such funds being transferred to any gaming establishment accounts (and thus saves users time and effort in having to set up such a gaming establishment account as well as save processing resources by reducing the quantity of accounts such funds have to travel to before reaching the gaming establishment device). Moreover, since certain gaming establishment patrons are uncomfortable venturing into a gaming establishment with large amounts of cash, the system enables a user access to an amount of funds transferred from an external account without the need to handle cash. Such reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based and ticket voucher-based transactions (e.g., protecting patrons from using forms of currency that act as transmission vehicles for contagions), and benefits the gaming establishment by reducing the use of certain kiosks that accept cash (e.g., reducing the wear and tear on such devices and prolonging the operational life on these devices).

Additionally, by reducing the amount of cash transactions in a gaming establishment via enabling the transfer of funds from an external account to a gaming establishment device, the system reduces or eliminates human errors which often occur when cash is distributed at gaming establishment interfaces, such as casino desks and/or ticket vouchers are purchased with an amount of cash at gaming establishment interfaces, such as casino desks. Specifically, eliminating gaming establishment personnel from distributing cash and/or issuing ticket vouchers in exchange for amounts of cash not only protects the user (if the gaming establishment personnel provides the gaming establishment patron a lower amount of cash and/or a lower valued ticket voucher than the patron deserves) but also protects the gaming establishment (if the gaming establishment personnel inadvertently or fraudulently provides the patron a higher amount of cash and/or or a higher valued ticket voucher than the patron deserves). As such, the system of the present disclosure provides an alternative, non-cash-based and non-ticket voucher-based option for a gaming establishment patron to transfer, independent of any gaming establishment accounts, funds to a gaming establishment device while complying with various anti-money laundering regulations and/or responsible gambling limitations which require the tracking of certain financial transactions associated with a gaming establishment patron.

In certain embodiments, one or more components of one or more systems associated with the transfer of funds apply certain money laundering detections, such as detecting certain structured transactions. In these embodiments, since the ability to transfer funds from an external account to an EGM without the involvement of any gaming establishment accounts and/or wagering account transfers creates potential money laundering risks, the system of the present disclosure detects certain potential money-laundering scenarios, and potentially blocks them and/or reports them by providing the appropriate information that must be filed with financial crimes regulators in a given jurisdiction.

In certain embodiments, the system tracks instances of a user transferring funds from an external account to an EGM and then cashing out such funds to an instrument unaffiliated with a user, such as a cashless ticket voucher. In such embodiments, the system utilizes the tracked funds relative to an amount of transacting against such funds at the EGM (e.g., were the tracked funds utilized in association with at least a threshold amount of wagering activity) to potentially determine any money-laundering activities. For example, the system tracks the amount wagered from an electronic funds transfer in deposit when the user presses a cashout button and determines, based on that tracked data and the user's historical cashout information from previous electronic fund transfer deposits, if the user is a money laundering risk.

In certain embodiments, the system tracks one or more sources of funds transferred to an EGM and situations in which the user cashed out such funds to an instrument unaffiliated with a user, such as a cashless ticket voucher. In such embodiments, the system utilizes the tracked sources of funds relative to an amount of transacting against such funds at the EGM to potentially determine any money-laundering activities. For example, the system determines, based on the source of funds, the amount of activity associated with such funds, historical sources of funds of the user and historical activities associated with such funds, if the user is a money laundering risk.

In embodiments in which the system determines that the user's activity represents a potential money laundering risk, the system takes zero, one or more actions. In certain embodiments, the system prohibits the user from performing further deposits. In one such embodiment, the look back period for the evaluation of whether the user's activity represents a potential money laundering risk could be one time period (e.g., last 24 hours), while the limit or ban could be a different period (e.g., a week).

In certain embodiments in which the system determines that the user's activity represents a potential money laundering risk, the system prohibits the user from performing further deposits until the user takes one or more actions. In one such embodiment, the system prompts the user to communicate with gaming establishment personnel (and/or a member of a payments team) to unlock the restrictions placed by the system on further deposits flagged as potential money laundering actions. In another such embodiment, the system prompts the user to enroll in a gaming establishment patron management system, such as enrolling to obtain a player tracking card, to potentially unlock (or modify) one or more restrictions associated with the user once the user is a known and registered user. In another such embodiment, the system prompts the user to participate in one or more know-your-customer checks to potentially unlock (or modify) one or more restrictions associated with the user once the user is a known and registered user. For example, the system tracks the cashless ticket vouchers that were cashed out by a user during a certain period of time, such as a single day, and specifically the total amount of funds cashed out to cashless ticket vouchers relative to an amount of funds of the cashless ticket voucher attributable to a previous electronic fund transfer deposit. In this example, upon the user's attempt to trigger another deposit of funds from an external account to an EGM (that occurs independent of any gaming establishment account), the system evaluates the amount of funds from such tracked electronic fund transfer deposits such that if the total amount of funds wagered for the day attributable to electronic fund transfer deposits divided by the total amount of electronic fund transfer deposits is below a threshold (which may be based on one or more factors, such as, but not limited to, an identity of the user, know-your-customer data associated with the user, a status of the user, any prior registration of the user, a ranking of the user in a gaming establishment patron management system), then the user may be prevented from triggering additional electronic fund transfer deposits.

In certain embodiments, in view of certain money laundering risks associated with transfers of funds from an external account that bypasses any gaming establishment account (and zero, one or more anti-money laundering protections associated with such gaming establishment accounts), the system invokes certain limits to only permit one source of funding to be active at a given point in time. In one such embodiment, if a user deposits funds onto the EGM using a bill validator, the system disables other funding sources to prevent the mixing of funds obtained via an external account (i.e., the system prevents mixing of funds with the cash obtained via the bill validator). In another embodiment, if a user funds the EGM's credit meter via funds from an external account, the system disables other funding sources, such as the bill validator, until the user has left the EGM, or the EGM's credit meter has been reduced to a threshold amount, such as a zero balance.

In certain additional or alternative embodiments, one or more components of the system reports on certain attempted and/or completed fund transactions from an external account. In one such embodiment, the system detects that a user has initiated a transfer (or a set of transfers) that at least reaches a regulatory reporting limit, and then the system notifies the operator that a regulatory report needs to be filed. Such an embodiment enables gaming establishment personnel the ability to have the appropriate information to file one or more suspicious activity reports with financial crimes regulatory agencies, such as the US Treasury's FinCEN. In another embodiment, the system facilitates the automatic filing of a regulatory report on behalf of the operator, such as automatically filling in the appropriate regulatory agency report (e.g., Suspicious Activity Report (SAR), Currency Transaction Report (CTR)) for submission by the gaming establishment to the regulatory body. In another such embodiment, the system electronically submits the generated reports to the appropriate regulatory body. In another embodiment, the system denies any automatic approval (such as one set up by a user) of an attempted transfer due to the transfer at least reaching a regulatory and/or operational control limit, and the system requires manual approval by gaming establishment personnel (and/or personnel of one or more financial institutions involved in the transfer transaction).

In certain embodiments, the system additionally (or alternatively) imposes certain deposit limits in association with funds transferred from an external account independent of any gaming establishment account (and the deposit limits associated with such gaming establishment accounts). That is, while certain jurisdictions supports various types of limits on funds associated with gaming establishment accounts (e.g., certain Nevada regulations require deposit limits on each instrument used to fund an account and other Nevada regulations require a cashless wagering account to enable a user to set a deposit limit over a desired period of time), such limits associated with gaming establishment accounts are different from limits associated with external accounts, such as financial institution accounts. Accordingly, if the funding of an EGM from an external account bypasses the employment of any gaming establishment account of a user, such as a cashless wagering account, then the system of the present disclosure will implement certain required limits (i.e., usage controls) because the gaming establishment account, such as the cashless wagering account, is not otherwise exposed to the funding/deposit operations. In different embodiments, these limits are applicable per external account, per payment instrument (e.g., per debit card associated with one or more external accounts), per unit of time (e.g., a daily deposit limit) and/or per transaction.

In certain embodiments, the system implements one or more transfer limits, usage controls and/or security measures. In these embodiments, one or more component of the system are tasked with monitoring activity associated with one or more external accounts used to transfer funds to a gaming establishment device independent of any gaming establishment account, such as EGM funding transactions, and accepting or rejecting such activity based on the currently configured limits associated with the external account relative to certain prior activity, if any, during an applicable period of time. In such embodiments, based on the compliance (or lack thereof) of one or more deposit limits imposed on funds transferred from the external account, such components of the system notifies the user of a status of the attempted deposit of funds to the EGM via a message displayed at any suitable device, via an email, via an SMS or text message, and/or via a notification displayed by a mobile device application. It should be appreciated that in certain instances, since the payment gateway has visibility into other types of deposit transactions, if the deposit limit needs to take account for these other types of deposit transactions, the payment gateway is relatively better situated to impose certain limits.

In certain embodiments, the system sets one or more limits per user and/or per payment instrument employed. In certain embodiments, the system enables one or more users to set one or more limits for that user. In certain of these embodiments, the system utilizes one or more attributes of the user, such as a player tracking account status of the user, in determining whether to enable the user to set one or more usage controls and/or security measures in association with that user.

In certain embodiments, in applying one or more transfer limit compliance determinations, the system employs the same limits per user and/or per payment instrument employed. In certain embodiments, in applying one or more transfer limit compliance determinations, the system employs different limits per user and/or per payment instrument employed. In certain such embodiments, the system applies varying limits depending upon who the user is and what levels of know-your-customer checks have been performed. For example, for users who do not provide any personally identifiable information beyond what is required for their payment to succeed, the system imposes a $500/day limit per funding instrument. On the other hand, for users who provide know-your-customer information (including, but not limited to, sharing a scan of their driver's license, a selfie picture and liveliness check) and/or who pass a know-your-customer check from a 3^{rd} party know-your-customer verification service or a human verification process), the system imposes a higher limit, such as a $2000/day limit per funding instrument.

In certain other embodiments, the system applies varying limits depending upon the user having one or more accounts associated with the gaming establishment, such as the user having a player's club account. For example, for users who do not have a player's club account, the system imposes a $500/day limit per funding instrument, but for users who have a player's club account, the system imposes a $5000/day limit per funding instrument. In certain additional embodiments, the system employs multiple factors in determining the limits to impose on attempted transfers from external accounts that occur independent of any gaming establishment account or wagering account transfers. For example, for a user who is anonymous, the system imposes a $500/day limit per funding instrument, for a user that enables a know-your-customer check to be performed, subject to the approval of that check, the system imposes a $2000/day limit per funding instrument, and for a user that additionally signs up for a player's club account, the system imposes a $5000/day limit per funding instrument. In this example, if the user whom has not enabled a know-your-customer check to be performed or signed up for a player's club account hits their daily limit, the system presents, via a message displayed at any suitable device, via an email, via an SMS or text message, and/or via a notification displayed by a mobile device application, the user any options (if available) to move to a higher limit, such as by signing up for a player's club account and/or enabling a know-your-customer check to occur.

Accordingly, in certain embodiments, in association with the movement of funds from an external account to a gaming establishment device and in view of the potential subsequent movement of such funds elsewhere, the system of the present disclosure imposes certain limits, such as responsible gaming limits and/or anti-money laundering limits. In certain such embodiments, since the transfer of funds from an external account bypasses any gaming establishment account maintained by a gaming establishment fund management system that otherwise includes capabilities to screen for violations of certain limits, the system operates to track funds transferred independent of the gaming establishment fund management system. In these embodiments, the system determines if any transactions, individually or collectively, violate one or more imposed limits, and takes zero, one or more appropriate actions accordingly. For example, since the transfer of funds from a financial institution account (i.e., an external account) to an electronic gaming machine (i.e., a gaming establishment device) occurs independent of any cashless wagering account maintained by a cashless wagering system that may otherwise impose funding limits, the system of the present disclosure enforces transfer limits on a periodic basis to ensure that responsible gambling limits are met and/or the system is not being abused to potentially launder money.

It should be appreciated that the electronic fund data transfers of the present disclosure may occur in addition to or as an alternative from cash-based fund transfers and/or cashless ticket voucher-based fund transfers. It should be further appreciated that any functionality or process of the present disclosure may be implemented via one or more servers (associated with or independent of any component of any system disclosed herein), a mobile device application, one or more gaming establishment devices (e.g., a gaming device such as an EGM or a non-gaming device such as a point-of-sale terminal of a retailer located within or otherwise associated with a gaming establishment), and/or one or more components of a gaming establishment system (such as a component of a gaming establishment patron management system supported by or otherwise located inside a gaming establishment device and/or a non-gaming establishment device). Accordingly: (i) while certain functions, features or processes are described herein as being performed by one (or more) device (e.g., a server, a mobile device application, a gaming establishment device, a component of a gaming establishment system), such functions, features or processes may alternatively be performed, if applicable, by another such different devices.

In certain embodiments, the above-described embodiments of the present disclosure may be implemented in accordance with or in conjunction with zero, one or more components of the system (e.g., a payment gateway, an external funding solution and/or an electronic funds transfer transaction service); zero, one or more components of a financial institution that maintains an external account; zero, one or more components of a gaming establishment system (e.g., a gaming establishment patron management system, a gaming establishment device management system, and/or a gaming establishment accounting system) and/or zero, one or more gaming establishment devices. In these embodiments, such components of the component of the system, the component of the financial institution that maintains the external account, the component of the gaming establishment system, and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the system, the component of the financial institution that maintains the external account, the component of the gaming establishment system, and/or the gaming establishment device; (3) accessing memory to configure or reconfigure parameters in the memory according to indicia read from the component of the system, the component of the financial institution that maintains the external account, the component of the gaming establishment system, and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the system, the component of the financial institution that maintains the external account, the component of the gaming establishment system, and/or the gaming establishment device, while in other embodiments, at least one component of the controller resides outside of the housing of the component of the system, the component of the financial institution that maintains the external account, the component of the gaming establishment system, and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the system, the component of the financial institution that maintains the external account, the component of the gaming establishment system, and/or the gaming establishment device disclosed herein. In certain embodiments, the at least one memory device resides within the housing of the component of the system, the component of the financial institution that maintains the external account, the component of the gaming establishment system, and/or the gaming establishment device, while in other embodiments at least one component of the at least one memory device resides outside of the housing of the component of the system, the component of the financial institution that maintains the external account, the component of the gaming establishment system, and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the system, the component of the financial institution that maintains the external account, the component of the gaming establishment system, and/or the gaming establishment device; (2) associations between configuration indicia read from the component of the system, the component of the financial institution that maintains the external account, the component of the gaming establishment system, and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the system, the component of the financial institution that maintains the external account, the component of the gaming establishment system, and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the system, the component of the financial institution that maintains the external account, the component of the gaming establishment system, and/or the gaming establishment device to control the component of the system, the component of the financial institution that maintains the external account, the component of the gaming establishment system, and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) uses such a removable memory device in a component of the gaming establishment fund management system to implement at least part of the present disclosure. In other embodiments, part or all of the program code and/or the operating data is downloaded to the at least one memory device of the component of the system, the component of the financial institution that maintains the external account, the component of the gaming establishment system, and/or the gaming establishment device through any suitable data network described above (such as an Internet or intranet).

The at least one memory device also stores a plurality of device drivers. Examples of different types of device drivers include device drivers for the component of the system, the component of the financial institution that maintains the external account, the component of the gaming establishment system, and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the system, the component of the financial institution that maintains the external account, the component of the gaming establishment system, and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the system, the component of the financial institution that maintains the external account, the component of the gaming establishment system, and/or the gaming establishment device loads the new device driver from the at least one memory device to enable communication with the new device. For instance, one type of card reader in the component of the system, the component of the financial institution that maintains the external account, the component of the gaming establishment system, and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the system, the component of the financial institution that maintains the external account, the component of the gaming establishment system, and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the system, the component of the financial institution that maintains the external account, the component of the gaming establishment system, and/or the gaming establishment device. For example, the display devices serve as digital glass configured to display aspects of the gaming establishment device. In various embodiments, the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. For example, after the gaming establishment device receives an actuation, the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. For example, the gaming establishment device provides dynamic sounds coupled with attractive multimedia images displayed on one or more of the display devices to provide an audio-visual representation or to otherwise display full-motion video with sound to attract users to the gaming establishment device. In certain embodiments, the gaming establishment device displays a sequence of audio and/or visual attraction messages during idle periods to attract potential users to the gaming establishment device. The videos may be customized to provide any appropriate information.

The at least one input device may include any suitable device that enables an input signal to be produced and received by the at least one processor of the component of the system, the component of the financial institution that maintains the external account, the component of the gaming establishment system, and/or the gaming establishment device. In one embodiment, the at least one input device includes a payment device configured to communicate with the at least one processor of the gaming establishment device to fund the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the gaming establishment device to be funded via an electronic funds transfer, such as a transfer of funds from a bank account. In another embodiment, the gaming establishment device includes a payment device configured to communicate with a mobile device of a user, such as a mobile phone, a radio frequency identification tag, or any other suitable wired or wireless device, to retrieve relevant information associated with that user to fund the gaming establishment device. When the gaming establishment device is funded, the at least one processor determines the amount of funds entered and displays the corresponding amount.

In various embodiments, the at least one input device includes a plurality of buttons that are programmable by the component of the system, the component of the financial institution that maintains the external account, the component of the gaming establishment system, and/or the gaming establishment device operator to, when actuated, cause the component of the system, the component of the financial institution that maintains the external account, the component of the gaming establishment system, and/or the gaming establishment device to perform particular functions. For instance, such buttons may be hard keys, programmable soft keys, or icons icon displayed on a display device of the gaming establishment device that are actuatable via a touch screen of the gaming establishment device or via use of a suitable input device of the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the system, the component of the financial institution that maintains the external account, the component of the gaming establishment system, and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the system, the component of the financial institution that maintains the external account, the component of the gaming establishment system, and/or the gaming establishment device, such as one or more rechargeable power sources (e.g., rechargeable batteries) located at the component of the system, the component of the financial institution that maintains the external account, the component of the gaming establishment system, and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the system, the component of the financial institution that maintains the external account, the component of the gaming establishment system, and/or the gaming establishment device; detecting the presence and/or identity of various persons (e.g., users, casino employees, etc.), devices (e.g., user input devices), and/or systems within a predetermined proximity to the component of the system, the component of the financial institution that maintains the external account, the component of the gaming establishment system, and/or the gaming establishment device.

The at least one data preservation component is configured to detect or sense one or more events and/or conditions that, for example, may result in damage to the component of the system, the component of the financial institution that maintains the external account, the component of the gaming establishment system, and/or the gaming establishment device and/or that may result in loss of information associated with the component of the system, the component of the financial institution that maintains the external account, the component of the gaming establishment system, and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the system, the component of the financial institution that maintains the external account, the component of the gaming establishment system, and/or the gaming establishment device to operate in a mobile environment.

The at least one geolocation module is configured to acquire geolocation information from one or more remote sources and use the acquired geolocation information to determine information relating to a relative and/or absolute position of the component of the system, the component of the financial institution that maintains the external account, the component of the gaming establishment system, and/or the gaming establishment device. For example, in one implementation, the at least one geolocation module is configured to receive GPS signal information for use in determining the position or location of the gaming establishment device. In another implementation, the at least one geolocation module is configured to receive multiple wireless signals from multiple remote devices and use the signal information to compute position/location information relating to the position or location of the gaming establishment device.

The at least one user identification module is configured to determine the identity of the current user or current owner of the component of the system, the component of the financial institution that maintains the external account, the component of the gaming establishment system, and/or the gaming establishment device. For example, in one embodiment, the current user is required to perform a login process at the component of the system, the component of the financial institution that maintains the external account, the component of the gaming establishment system, and/or the gaming establishment device in order to access one or more features. Alternatively, the component of the system, the component of the financial institution that maintains the external account, the component of the gaming establishment system, and/or the gaming establishment device is configured to automatically determine the identity of the current user based on one or more external signals, such as an RFID tag or badge worn by the current user and that provides a wireless signal to the component of the system, the component of the financial institution that maintains the external account, the component of the gaming establishment system, and/or the gaming establishment device that is used to determine the identity of the current user. In at least one embodiment, various security features are incorporated into the component of the system, the component of the financial institution that maintains the external account, the component of the gaming establishment system, and/or the gaming establishment device to prevent unauthorized users from accessing confidential or sensitive information.

The at least one information filtering module is configured to perform filtering (e.g., based on specified criteria) of selected information to be displayed at one or more displays of the component of the system, the component of the financial institution that maintains the external account, the component of the gaming establishment system, and/or the gaming establishment device.

In various embodiments, the component of the system, the component of the financial institution that maintains the external account, the component of the gaming establishment system, and/or the gaming establishment device includes a plurality of communication ports configured to enable the at least one processor of the component of the system, the component of the financial institution that maintains the external account, the component of the gaming establishment system, and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the system, the component of the financial institution that maintains the external account, the component of the gaming establishment system, and/or the gaming establishment device has a support structure, housing, or cabinet that provides support for a plurality of the input devices and the output devices of the component of the system, the component of the financial institution that maintains the external account, the component of the gaming establishment system, and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor, cause the processor to:
responsive to a request to transfer an amount of funds from a financial institution account maintained by a financial institution to a gaming establishment device, and responsive to a transfer limit compliance determination being that the requested transfer complies with a transfer limit, communicate, to a server of the financial institution, data associated with the transfer of the amount of funds from the financial institution account, wherein the transfer limit compliance determination occurs independent of any component of any gaming establishment fund management system that maintains any gaming establishment accounts, and
responsive to the request to transfer the amount of funds from the financial institution account to the gaming establishment device, and responsive to the transfer limit compliance determination being that the requested transfer fails to comply with the transfer limit, communicate data that results in a display, by a display device, of a notification associated with the requested transfer failing to comply with the transfer limit.

2. The system of claim 1, wherein the memory devices stores a plurality of further instructions that, when executed by the processor responsive to a receipt, from the server of the financial institution, of data associated with an approval of the transfer of the amount of funds from the financial institution account, cause the processor to cause a modification of a balance of the gaming establishment device, wherein the transfer occurs independent of any wagering account transfers.

3. The system of claim 1, wherein the transfer limit is associated with an amount transferrable from the financial institution account over a period of time.

4. The system of claim 1, wherein the transfer limit is associated with an amount transferrable in association with a user over a period of time.

5. The system of claim 4, wherein an anonymous user is associated with a first amount transferrable over the period of time and an identified user is associated with a second, different amount transferrable over the period of time.

6. The system of claim 1, wherein the request to transfer the amount of funds from the financial institution account to the gaming establishment device is associated with transfer context data identifying the gaming establishment device.

7. The system of claim 1, wherein the transfer limit comprises a responsible gaming limit.

8. The system of claim 7, wherein the responsible gaming limit is set by a user.

9. The system of claim 1, wherein the transfer limit compliance determination occurs independent of the server of the financial institution.

10. A system comprising:
a processor; and
a memory device that stores a plurality of instructions that, when executed by the processor, cause the processor to:
responsive to a request by a first user to transfer an amount of funds from a first financial institution account maintained by a financial institution to an electronic gaming machine, and responsive to a first transfer limit compliance determination being that the requested transfer complies with a first transfer limit associated with the first user, communicate, to a server of the financial institution, data associated with the transfer of the amount of funds from the first financial institution account, wherein the first transfer limit compliance determination occurs independent of the server of the financial institution, independent of the electronic gaming machine and independent any component operable to execute any wagering account transfer, and
responsive to a request by a second user to transfer the amount of funds from a second financial institution account maintained by the financial institution to the electronic gaming machine, and responsive to a second transfer limit compliance determination being that the requested transfer fails to comply with a second, different transfer limit associated with the second user, communicate data that results in a display, by a display device, of a notification associated with the requested transfer failing to comply with the second, different transfer limit, wherein the second transfer limit compliance determination occurs independent of the server of the financial institution, independent of the electronic gaming machine and independent any component operable to execute any wagering account transfer.

11. The system of claim 10, wherein the first user and the second user are the same user at different points in time.

12. A method of operating a system, the method comprising:
responsive to a request to transfer an amount of funds from a financial institution account maintained by a financial institution to a gaming establishment device, and responsive to a transfer limit compliance determination being that the requested transfer complies with a transfer limit, communicating, to a server of the financial institution, data associated with the transfer of the amount of funds from the financial institution account, wherein the transfer limit compliance determination occurs independent of any component of any gaming establishment fund management system that maintains any gaming establishment accounts, and
responsive to the request to transfer the amount of funds from the financial institution account to the gaming establishment device, and responsive to the transfer limit compliance determination being that the requested transfer fails to comply with the transfer limit, displaying, by a display device, a notification associated with the requested transfer failing to comply with the transfer limit.

13. The system of claim 12, further comprising, responsive to a receipt, from the server of the financial institution, of data associated with an approval of the transfer of the amount of funds from the financial institution account, causing, by a processor, a modification of a balance of the gaming establishment device, wherein the transfer occurs independent of any wagering account transfers.

14. The method of claim 12, wherein the transfer limit is associated with an amount transferrable from the financial institution account over a period of time.

15. The method of claim 12, wherein the transfer limit is associated with an amount transferrable in association with a user over a period of time.

16. The method of claim 15, wherein an anonymous user is associated with a first amount transferrable over the period of time and an identified user is associated with a second, different amount transferrable over the period of time.

17. The method of claim 12, wherein the request to transfer the amount of funds from the financial institution account to the gaming establishment device is associated with transfer context data identifying the gaming establishment device.

18. The method of claim 12, wherein the transfer limit comprises a responsible gaming limit.

19. The method of claim 18, wherein the responsible gaming limit is set by a user.

20. The method of claim 12, wherein the transfer limit compliance determination occurs independent of the server of the financial institution.
